(19) United States
(12) Patent Application Publication
(10) Pub. No.: US 2026/0358932 A1
(43) Pub. Date: Nov. 12, 2026

(54) CONTROL DEVICE, CONTROL METHOD, AND RECORDING MEDIUM

(71) Applicant: NEC Corporation, Tokyo (JP)

(72) Inventors: Masatsugu OGAWA, Tokyo (JP); Tatsuhiko NAKABAYASHI, Tokyo (JP)

(73) Assignee: NEC Corporation, Tokyo (JP)

(21) Appl. No.: 19/488,132

(22) PCT Filed: Jul. 6, 2023
(86) PCT No.: PCT/JP2023/025130

§ 371 Date: Nov. 26, 2025

(51) Int. Cl. G06F 3/0482; B25J 13/06; G06F 3/0488

(52) U.S. Cl. CPC G06F 3/0482; B25J 13/06; G06F 3/0488

(57) ABSTRACT

A control device is provided with a controller for creating display information including an input form for receiving an input from the outside, and information relating to the operation of a robot, the information being displayed so as to be superimposed on the input form.

### TECHNICAL FIELD

The present disclosure relates to a control device, a control method, and a recording medium.

### BACKGROUND ART

Robots are used in various fields such as logistics. PTL 1 discloses a technique related to a robot system having a configuration capable of efficiently accessing desired information, as a related art.

### CITATION LIST

### Patent Literature

PTL 1: JP 2020-121351 A

### SUMMARY OF INVENTION

### Technical Problem

In a robot system described in PTL 1 or the like, there is a case where a robot and a worker cooperate with each other and the robot performs a work instead of the worker. In this case, the robot is required to execute an operation similar to the worker. Therefore, there is a demand for a technology capable of controlling software related to a work regardless of a type of an operation subject.

An object of each aspect of the present disclosure is to provide a control device, a control method, and a recording medium that can solve the above problem.

### Solution to Problem

According to one aspect of the present disclosure, a control device includes control means for creating display information including an input form for receiving an input from outside and information regarding an operation of a robot, displayed to be superimposed on the input form.

According to another aspect of the present disclosure, a control method includes creating display information including an input form for receiving an input from outside and information regarding an operation of a robot, displayed to be superimposed on the input form.

### Advantageous Effects of Invention

According to each aspect of the present disclosure, it is possible to control software related to a work regardless of a type of an operation subject.

### BRIEF DESCRIPTION OF DRAWINGS

FIG. 1 is a diagram illustrating an example of a configuration of a processing system according to one example embodiment of the present disclosure.

FIG. 2 is a diagram illustrating an example of a configuration of a management system according to one example embodiment of the present disclosure.

FIG. 3 is a diagram illustrating a first example of display of a display unit according to one example embodiment of the present disclosure.

FIG. 4 is a diagram illustrating a second example of the display of the display unit according to one example embodiment of the present disclosure.

FIG. 5 is a diagram illustrating a third example of the display of the display unit according to one example embodiment of the present disclosure.

FIG. 6 is a diagram illustrating a fourth example of the display of the display unit according to one example embodiment of the present disclosure.

FIG. 7 is a diagram illustrating a fifth example of the display of the display unit according to one example embodiment of the present disclosure.

FIG. 8 is a diagram illustrating a sixth example of the display of the display unit according to one example embodiment of the present disclosure.

FIG. 9 is a diagram illustrating an example of a configuration of a robot system according to one example embodiment of the present disclosure.

FIG. 10 is a diagram illustrating a seventh example of the display of the display unit according to one example embodiment of the present disclosure.

FIG. 11 is a diagram illustrating an example of a sequence of a plan generated by a generation unit according to one example embodiment of the present disclosure.

FIG. 12 is a diagram illustrating an example of a control signal of a plan generated by a controller according to one example embodiment of the present disclosure.

FIG. 13 is a diagram illustrating an example of a processing flow of the processing system according to one example embodiment of the present disclosure.

FIG. 14 is an image diagram of a surrounding environment of the processing system according to one example embodiment of the present disclosure.

FIG. 15 is an image diagram of the surrounding environment of the processing system according to one example embodiment of the present disclosure.

FIG. 16 is a diagram illustrating an example of a control device having a minimum configuration according to one example embodiment of the present disclosure.

FIG. 17 is a diagram illustrating an example of a processing flow of the control device having the minimum configuration according to one example embodiment of the present disclosure.

FIG. 18 is a schematic block diagram illustrating a configuration of a computer according to at least one example embodiment.

### EXAMPLE EMBODIMENT

Hereinafter, example embodiments will be described in detail with reference to the drawings.

### Example Embodiment

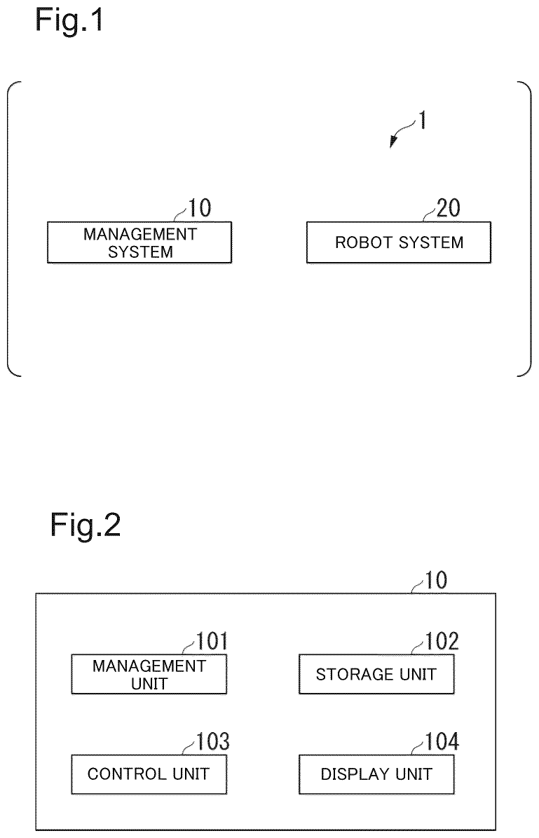

A processing system 1 according to one example embodiment of the present disclosure will be described. The processing system 1 includes at least a management system 10. Then, a robot system 20 that works instead of a worker can be introduced into the processing system 1. FIG. 1 is a diagram illustrating an example of a configuration of the processing system 1 according to one example embodiment of the present disclosure. The processing system 1 illustrated in FIG. 1 indicates an example of a configuration after the robot system 20 has been introduced. Hereinafter, as a specific example of the work, a sorting work for transferring a product M in cardboard C conveyed by a belt conveyor to a tray T, putting the tray T on another belt conveyor, and moving the tray T to a predetermined position is exemplified, and the processing system 1 in which the robot system 20 is introduced will be described.

As illustrated in FIG. 1, the processing system 1 includes the management system 10 (example of control device) and the robot system 20.

FIG. 2 is a diagram illustrating an example of a configuration of the management system 10 according to one example embodiment of the present disclosure. As illustrated in FIG. 2, the management system 10 includes a management unit 101, a storage unit 102, a control unit 103, and a display unit 104.

The management unit 101 writes a status of each work into the storage unit 102. For example, the management unit 101 writes the status of each work into the storage unit 102 based on an input from outside received via an input form, to be described later, displayed on the display unit 104. The input form is a form for receiving an input from outside. Examples of the input form are a radio button, a check box, a menu (including drop-down menu), or the like. Specifically, for example, in a case where the display unit 104 displays a finish button as the input form, the management unit 101 determines whether the finish button is touched. In a case of determining that the finish button is touched, the management unit 101 determines that a work related to the finish button has been completed. Then, the management unit 101 writes a completion flag indicating that the work has been completed into the storage unit 102, in association with the work determined to be completed.

The storage unit 102 stores various types of information necessary for processing executed by the management system 10. For example, the storage unit 102 stores the status of each work. Specifically, for example, the storage unit 102 stores 0 (incomplete) or 1 (completed) flag in association with the work. For example, the storage unit 102 stores information to be displayed on the display unit 104 by the control unit 103 according to the status of each work. The information to be displayed on the display unit 104 by the control unit 103 according to the status of each work includes the input form and information regarding an operation of a robot 205, to be described later, displayed to be superimposed on the input form. Examples of the information regarding the operation of the robot 205 include yes (YES), no (NO), a command to the robot 205, or the like.

Examples of the command to the robot 205 include a command to touch a predetermined portion in a case where a certain work is completed, a command to touch a predetermined portion before start of a certain work, or the like. Among the information to be displayed on the display unit 104 by the control unit 103 according to the status of each work, information directly operated by the robot 205 on the display unit 104 is associated with a specific figure. Examples of the specific figure include an Augmented Reality (AR) marker, a Quick Response (QR) code, a geometric figure such as ○ (circle) or Δ (triangle), or the like.

The control unit 103 generates display information including the input form and the information regarding the operation of the robot 205 displayed to be superimposed on the input form. The control unit 103 controls display of the generated display information on the display unit 104. For example, the control unit 103 displays the generated display information on the display unit 104. For example, the control unit 103 changes display content of the display information displayed on the display unit 104, after a predetermined operation of the robot 205 has been completed. For example, the control unit 103 hides the display of the display information displayed on the display unit 104, after the predetermined operation of the robot 205 has been completed. For example, the control unit 103 displays the display information on the display unit 104, at a timing when the operation of the robot has been completed in a predetermined process or an estimated timing when the operation of the robot is likely to be completed in the predetermined process. The display information may be information indicating control content for the robot 205. The display information may be information indicating a desired state to be achieved by the robot 205.

The display unit 104 displays the display information, under control of the control unit 103. For example, the display unit 104 displays the input form and the information regarding the operation of the robot 205, displayed to be superimposed on the input form, under the control of the control unit 103. For example, the display unit 104 displays the specific figure, associated with the information directly operated by the robot 205 on the display unit 104, among the information displayed according to the status of each work, under the control of the control unit 103. For example, the display unit 104 is a display with a touch panel function. For example, the display unit 104 is installed at a work place.

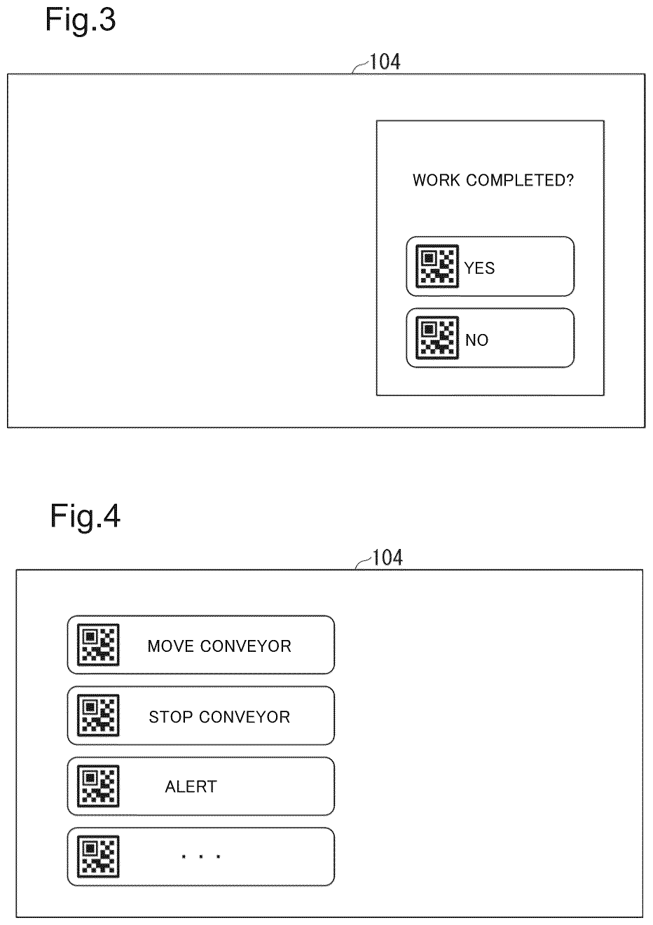

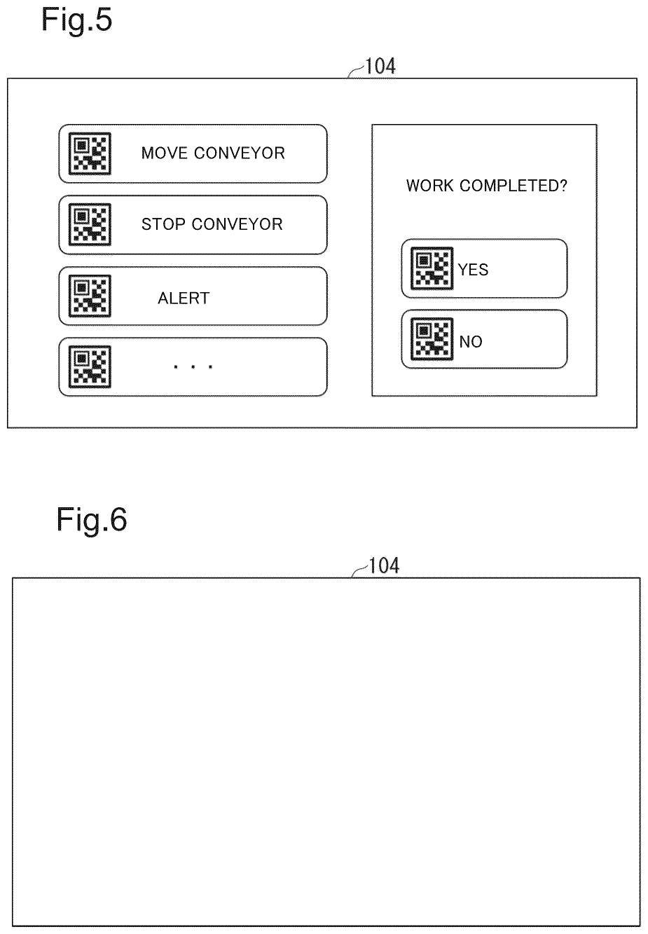

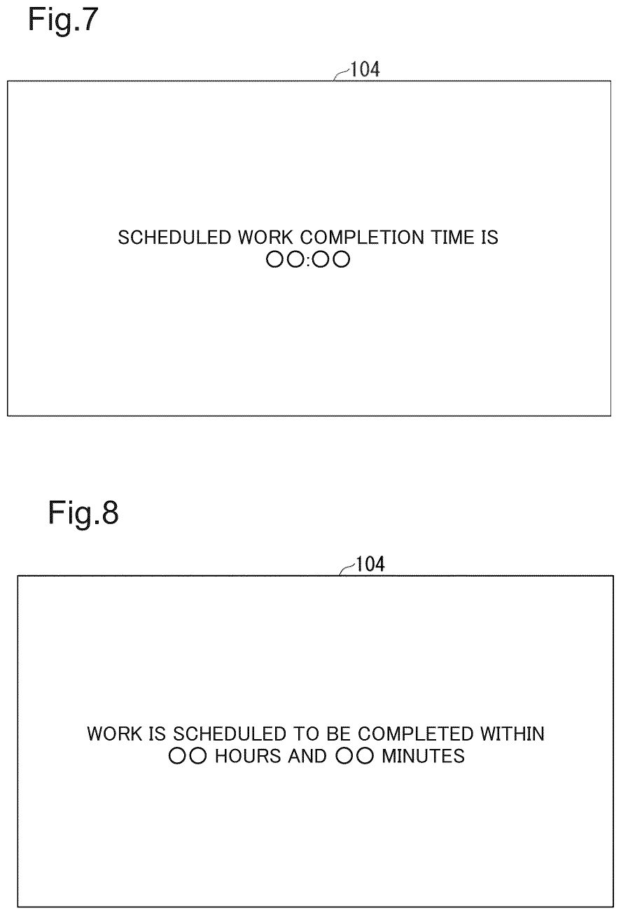

FIG. 3 is a diagram illustrating a first example of the display of the display unit 104 according to one example embodiment of the present disclosure. FIG. 4 is a diagram illustrating a second example of the display of the display unit 104 according to one example embodiment of the present disclosure. FIG. 5 is a diagram illustrating a third example of the display of the display unit 104 according to one example embodiment of the present disclosure. FIG. 6 is a diagram illustrating a fourth example of the display of the display unit 104 according to one example embodiment of the present disclosure. FIG. 7 is a diagram illustrating a fifth example of the display of the display unit 104 according to one example embodiment of the present disclosure. FIG. 8 is a diagram illustrating a sixth example of the display of the display unit 104 according to one example embodiment of the present disclosure. For example, the display unit 104 displays a button indicating an AR marker that is a specific figure related to selection content used to select whether the work has been completed as “YES” or “NO”, in a frame, as illustrated in FIG. 3, at a predetermined timing, under the control of the control unit 103. For example, the display unit 104 displays work content of a next process (example of predetermined process) and an AR marker which is a specific figure related to the content in a frame, at the predetermined timing, as illustrated in FIG. 4, under the control of the control unit 103. For example, the display unit 104 displays a button indicating the work content of the next process (example of predetermined process) and an AR marker which is a specific figure related to selection content used to select whether the work has been completed as “YES” or “NO”, in a frame, at the predetermined timing, as illustrated in FIG. 5, under the control of the control unit 103. For example, the display unit 104 hides the displayed information at the predetermined timing, under the control of the control unit 103, as illustrated in FIG. 6. For example, the display unit 104 displays a completion schedule (example of estimated timing) of the operation of the robot 205 in a current process (example of predetermined process) at the predetermined timing, as illustrated in FIG. 7 or 8, under the control of the control unit 103. Examples of the predetermined timing include after the completion of the operation of the robot 205, an estimated completion timing of the operation of the robot 205, a start time of a predetermined process, an end time of a predetermined process, or the like.

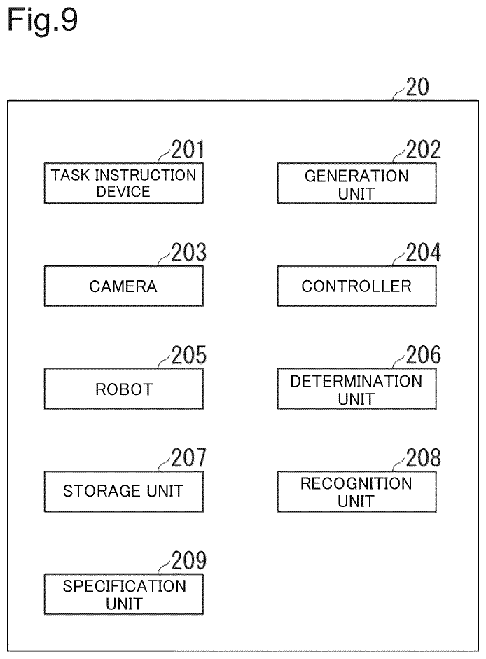

FIG. 9 is a diagram illustrating an example of a configuration of the robot system 20 according to one example embodiment of the present disclosure. As illustrated in FIG. 9, the robot system 20 includes a task instruction device 201, a generation unit 202, a camera 203, a controller 204, the robot 205, a determination unit 206, a storage unit 207, a recognition unit 208, and a specification unit 209.

The task instruction device 201 instructs the controller 204 to perform a task for causing the robot 205 to execute a desired work. For example, the task instruction device 201 instructs the controller 204 to perform the task, via a network (in some cases, using cloud service).

For example, the desired work is a sorting work for moving the product M in the cardboard C to the tray T which is a destination, determining whether the work for moving the product M to the tray T is completed, and moving the tray T to a predetermined position by the belt conveyor, in a case of determining that the work has been completed, the task instruction device 201 inputs a work target and a constraint condition into the generation unit 202, as processing for instructing the task. Examples of the work target include a type of the product M, a number of the products M to be moved, a movement source of the product M, information indicating a destination of the product M, information indicating a unit of a predetermined work for confirming the completion of the work, or the like. Examples of the constraint condition include an entry prohibition region when moving the product M, a region departing from a movable range of the robot 205, and in addition, conditions of a surface of the product M regarding gripping the product M, releasing the gripping of the product M, or regripping the product M. The task instruction device 201 may receive, for example, an input of “moving six parts A from the cardboard C to the tray T” from the worker, as the work target and specify that the type of the product M to be moved is the part A, the number of products M to be moved is six, the movement source of the product M is the cardboard C, and the destination of the product M is the tray T. Then, the task instruction device 201 may input the specified information into the generation unit 202. The task instruction device 201 may receive, for example, as the work target, an input such that “the units of the predetermined work for confirming completion of the work include a first work for stopping the belt conveyor used to move the cardboard C at the position of the robot 205, a second work for moving the cardboard C from the stopping position of the belt conveyor onto a work table F, a third work for moving the product M in the cardboard C on the work table F to the tray T, a fourth work for stopping the belt conveyor used to move the tray T, a fifth work for moving the tray T on the belt conveyor used to move the tray T, and a sixth work for moving the belt conveyor used to move the tray T”, from the worker and may cause the generation unit 202 to generate processing for confirming completion of the work after each of the first to sixth works. The task instruction device 201 may set a position of the product M specified in information to be described later acquired by the camera 203, as the movement source of the product M. For example, the task instruction device 201 may receive a position of an obstacle while moving the product M from the movement source to the destination as a constraint condition indicating the entry prohibition region, from the worker and input the information into the generation unit 202. A file indicating the constraint condition may be stored, for example, in the storage unit 207 and the task instruction device 201 may input the constraint condition indicated by the file into the generation unit 202, or the generation unit 202 may directly read the constraint condition from the file, or both may be performed. That is, the acquisition method may be any method, as long as the generation unit 202 can acquire the necessary work target and the necessary constraint condition.

The generation unit 202 generates a plan indicating a flow of the operation of the robot 205, based on the work target and the constraint condition input by the task instruction device 201.

For example, when the work target and the constraint condition are input by the task instruction device 201, the generation unit 202 generates a first sequence for performing determination whether the cardboard C has moved to the position of the robot 205 until it is determined that the cardboard C has moved and stopping the belt conveyor used to move the cardboard C in a case of determining that the cardboard C has moved. The generation unit 202 generates a second sequence for confirming whether the work according to the first sequence has been completed. The first sequence is a sequence related to the first work. The second sequence is a sequence generated by the generation unit 202 according to the first work that is the unit of the predetermined work for confirming the completion of the work.

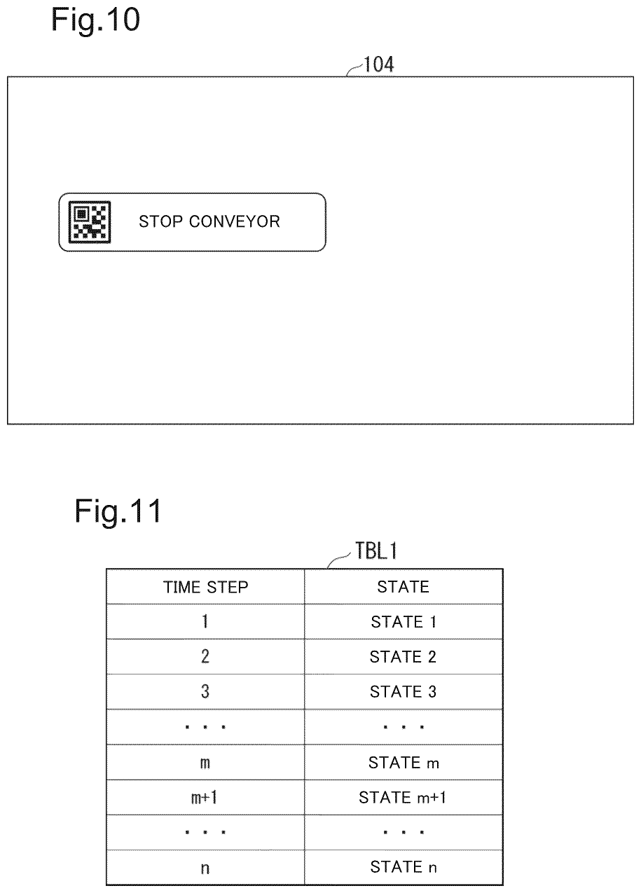

FIG. 10 is a diagram illustrating a seventh example of the display of the display unit 104 according to one example embodiment of the present disclosure. FIG. 10 is a diagram illustrating an example of display displayed by the display unit 104 when the robot 205 stops the belt conveyor. When the robot 205 stops the belt conveyor, the display unit 104 displays a button BT1 including a specific figure for stopping the belt conveyor as illustrated in FIG. 10. For example, the robot 205 touches the button BT1 displayed on the display unit 104 in such a way as to stop the belt conveyor. When the robot 205 stops the belt conveyor, the display unit 104 may or may not display a command to stop the belt conveyor, together with the button BT1. For example, when the robot 205 stops the belt conveyor, the display unit 104 may display only the button BT1 and display information indicating a command to be executed after the belt conveyor has been stopped by the robot 205. That is, it is sufficient for the display unit 104 to display a button for the robot 205 to execute predetermined processing at the predetermined timing and display a command to be executed as necessary, under the control of the control unit 103.

For example, the generation unit 202 generates a third sequence for moving the cardboard C from a stop position of the belt conveyor onto the work table F. The generation unit 202 generates a fourth sequence for confirming whether the work according to the third sequence has been completed. The third sequence is a sequence related to the second work. The fourth sequence is a sequence generated by the generation unit 202 according to the second work that is the unit of the predetermined work for confirming the completion of the work.

For example, the generation unit 202 generates a fifth sequence for moving the product M in the cardboard C on the work table F to the tray T. The generation unit 202 generates a sixth sequence for confirming whether the work according to the fifth sequence has been completed. The fifth sequence is a sequence related to the third work. The sixth sequence is a sequence generated by the generation unit 202 according to the third work that is the unit of the predetermined work for confirming the completion of the work.

More specifically, the generation unit 202 acquires two-dimensional and three-dimensional information to be described later at the movement source of the product M indicated by the work target, from the camera 203. The generation unit 202 can recognize a state of the product M at the movement source (that is, position and posture), based on the two-dimensional and three-dimensional information acquired from the camera 203. The generation unit 202 generates a moving route including a state of the product M from a state at the movement source of the product M to a state at the destination of the product M, for example, by simulation. Information indicating the moving route is information necessary for generating a control signal for controlling the robot 205 by the controller 204. Then, the generation unit 202 generates information indicating each state of the robot 205 at each time step in the middle (type of product M (including shape), position and posture of robot 205, operation of robot 205 (strength of gripping product M or the like), or the like) (that is, fifth sequence), for example, by simulation.

For example, the generation unit 202 generates a seventh sequence for stopping the belt conveyor that moves the tray T. The generation unit 202 generates an eighth sequence for confirming whether the work according to the seventh sequence has been completed. The seventh sequence is a sequence related to the fourth work. The eighth sequence is a sequence generated by the generation unit 202 according to the fourth work that is the unit of the predetermined work for confirming the completion of the work.

For example, the generation unit 202 generates a ninth sequence for moving the tray T onto the belt conveyor that moves the tray T. The generation unit 202 generates a tenth sequence for confirming whether the work according to the ninth sequence has been completed. The ninth sequence is a sequence related to the fifth work. The tenth sequence is a sequence generated by the generation unit 202 according to the fifth work that is the unit of the predetermined work for confirming the completion of the work.

For example, the generation unit 202 generates an eleventh sequence for moving the belt conveyor that moves the tray T. The generation unit 202 generates a twelfth sequence for confirming whether the work according to the eleventh sequence has been completed. The eleventh sequence is a sequence related to the sixth work. The twelfth sequence is a sequence generated by the generation unit 202 according to the sixth work that is the unit of the predetermined work for confirming the completion of the work. Then, the generation unit 202 outputs the generated sequence to the controller 204, each time when the generation unit 202 generates each of the first sequence to the twelfth sequence.

FIG. 11 is a diagram illustrating an example of a sequence TBL1 of a plan generated by the generation unit 202 according to one example embodiment of the present disclosure. For example, the sequence TBL1 of the plan generated by the generation unit 202 is a sequence indicating each state of the robot 205, for example, for each of n time steps from the movement source of the product M to the destination, as illustrated in FIG. 11.

The camera 203 is provided at a position where a work performed by the robot system 20 can be viewed (for example, above robot 205). The camera 203 includes a two-dimensional camera 2031 and a depth camera 2032.

The two-dimensional camera 2031 acquires two-dimensional information (that is, plane image) of an object to be imaged. The depth camera 2032 acquires three-dimensional information of the object to be imaged including depth information.

The controller 204 generates the control signal for controlling the robot 205, based on the sequence output by the generation unit 202. The controller 204 may generate a control signal for optimizing an evaluation function when generating the control signal. Examples of the evaluation function include a function indicating an amount of energy consumed by the robot 205 when the product M is moved, a function indicating a distance along a route along which the product M is moved, or the like. The controller 204 outputs the generated control signal to the robot 205.

In a case where it is determined that the work has been completed in the determination of whether the work has been completed made for each work in a predetermined unit in the plan by the determination unit 206, the controller 204 generates, for example, a control signal for causing the robot 205 to touch a specific figure in a three-dimensional space of a work place specified by the specification unit 209, with a stylus pen. Then, the controller 204 outputs the generated control signal to the robot 205.

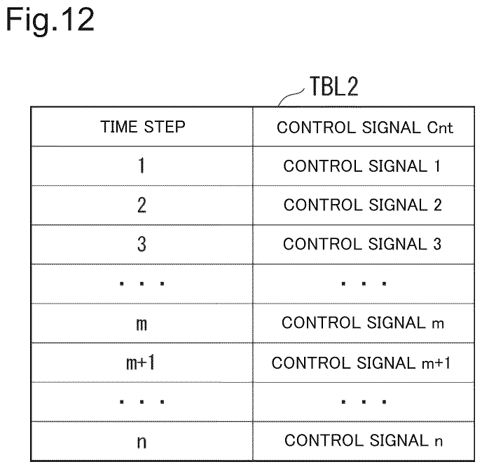

FIG. 12 is a diagram illustrating an example of a control signal Cnt of a plan generated by the controller 204 according to one example embodiment of the present disclosure. For example, the control signal Cnt of the plan generated by the controller 204 is, for example, each control signal for each of the n time steps from the movement source of the product M to the destination, as illustrated in FIG. 12.

The robot 205 operates in response to the control signal generated by the controller 204. For example, in a case where the control signal is the control signal for moving the product M from the movement source to the destination, the robot 205 moves the gripped product M from the movement source to the destination, in response to the control signal. In each example embodiment of the present disclosure, “gripping” includes “suction” for sucking a target M with a vacuum or the like and “holding” for holding an object with two or more pseudo fingers imitating fingers of a human, an animal, or the like. For example, in a case where the control signal is the control signal for touching the specific figure in the three-dimensional space of the work place with the stylus pen, the robot 205 touches the specific figure with the stylus pen, in response to the control signal. The stylus pen can be housed in the robot 205 and may appear from a housing place when the robot 205 touches a predetermined figure with the stylus pen.

The determination unit 206 determines whether the work has been completed, for each work in the predetermined unit in the plan. For example, in a case where the determination unit 206 makes determination on the third work, the determination unit 206 determines whether the product M is within a predetermined range, based on the information regarding the product M acquired by the camera 203 at a moving destination, according to the sixth sequence. Then, for example, in a case of determining that the product M is within the predetermined range, based on the information regarding the product M acquired by the camera 203 at the moving destination, the determination unit 206 determines that the third work has been completed. For example, in a case of determining that the product M is not within the predetermined range, based on the information regarding the product M acquired by the camera 203 at the moving destination, the determination unit 206 determines that the work under the control of the plan has not been completed.

In a case where the determination unit 206 determines that the work under the control of the plan has been completed, for example, the controller 204 generates the control signal for causing the robot 205 to touch the specific figure related to the completion of the work, with the stylus pen. Then, the controller 204 outputs the generated control signal to the robot 205.

In a case where the determination unit 206 determines that the work under the control of the plan has not been completed, for example, the controller 204 may generate the control signal for moving the product M to be within the predetermined range again, based on the information regarding the product M acquired by the camera 203 at the moving destination. Then, the controller 204 may output the generated control signal to the robot 205.

In a case where the determination unit 206 determines that the work under the control of the plan has not been completed, the controller 204 may cause the worker to confirm that the work has not been completed, for example, by notifying the task instruction device 201 or the like of that the work has not been completed, instead of the processing described above. Then, in a case where the worker confirms that the work has not been completed, the worker may instruct the processing system 1 to move the product M to be within the predetermined range or the worker may move the product M to be within the predetermined range.

The storage unit 207 stores various types of information necessary for processing executed by the robot system 20. For example, the storage unit 207 stores the file indicating the constraint condition, a reference figure for the recognition unit 208 to specify the specific figure, or the like.

The recognition unit 208 specifies the specific figure displayed on the display unit 104, in the information acquired by the camera 203 (that is, plane image). For example, the recognition unit 208 compares information regarding each reference figure stored in the storage unit 207 with the information acquired by the camera 203. Then, in a case where a matching degree based on the comparison result is equal to or more than a predetermined degree, the recognition unit 208 specifies the matching figure and a position of the matching figure in the information acquired by the camera 203.

The specification unit 209 specifies a posture (position and direction) of the figure in the three-dimensional space of the work place. For example, in a case where the matching figure specified by the recognition unit 208 is the AR marker, the specification unit 209 specifies a posture of the figure in the three-dimensional space of the work place, from the matching figure specified by the recognition unit 208. The AR marker includes three-dimensional information including an x direction, a y direction, and a z direction in the three-dimensional space of the work place and information regarding directions related to three pieces of information including roll, pitch, and yaw. The x direction is, for example, one direction included in a floor plane of the work place. For example, the y direction is a direction included in the floor plane and perpendicular to the x direction. The z direction is, for example, a direction perpendicular to the floor plane. That is, the AR marker includes six-dimensional information that can specify a posture. Therefore, in a case where the matching figure specified by the recognition unit 208 is the AR marker, the specification unit 209 can specify the posture of the figure in the three-dimensional space of the work place, only based on the matching figure specified by the recognition unit 208.

For example, in a case where the matching figure specified by the recognition unit 208 is a specific figure other than the AR marker, the specification unit 209 specifies a position of the matching figure in the information acquired by the camera 203. Then, it is sufficient for the specification unit 209 to specify a posture (position and direction) of the specific figure in the three-dimensional space of the work place, from information related to the information acquired by the camera 203 with respect to the specified position of the figure (that is, three-dimensional information of display unit 104), among the information acquired by the camera 203.

The processing executed by the processing system 1 in each example embodiment of the present disclosure is not limited to the above-described processing. For example, the processing system 1 may execute the processing described below.

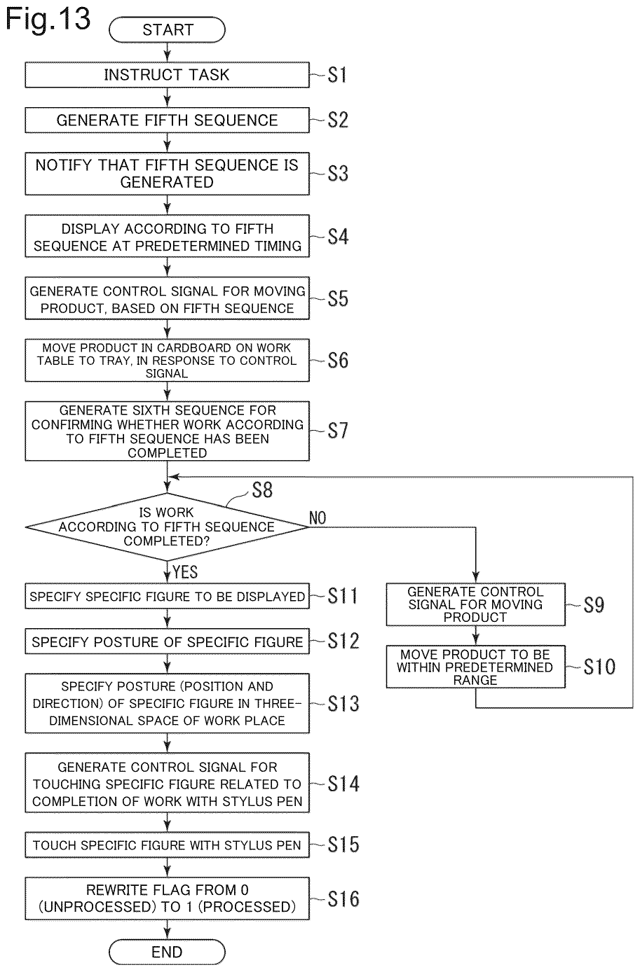

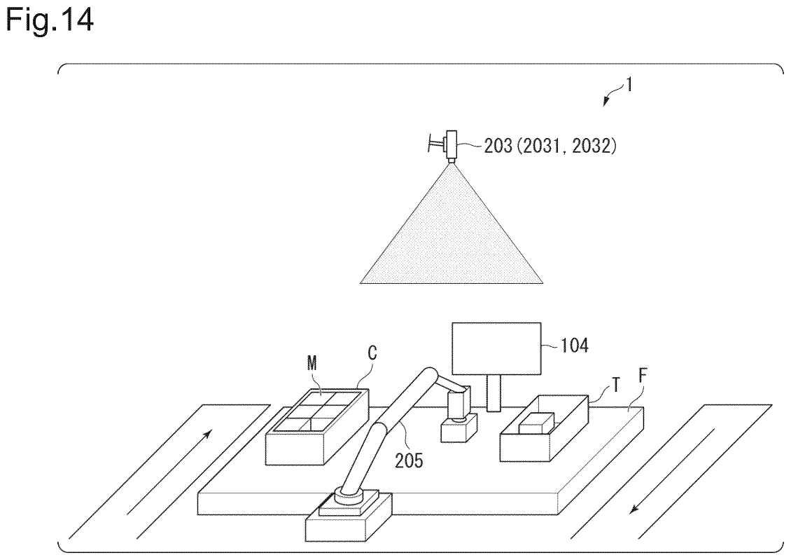

FIG. 13 is a diagram illustrating an example of a processing flow of the processing system 1 according to one example embodiment of the present disclosure. FIG. 14 is an image diagram of a surrounding environment of the processing system 1 according to one example embodiment of the present disclosure. Next, processing by the processing system 1 including the processing for displaying the specific figure will be described with reference to FIGS. 13 and 14. It is assumed that the task instruction device 201 instruct the controller 204 to perform a task for causing the robot 205 to execute a sorting work for transferring the product M in the cardboard C conveyed by the belt conveyor illustrated in FIG. 14 to the tray T, putting the tray T on another belt conveyor, and moving the tray T to a predetermined position, as the desired work. It is assumed that the two-dimensional camera 2031 acquires the two-dimensional information (that is, plane image) of the object to be imaged. It is assumed that the depth camera 2032 acquires the three-dimensional information of the object to be imaged including the depth information. The processing according to the fifth sequence and the sixth sequence related to the third work is exemplified as a specific example of the processing executed by the processing system 1, and the processing executed by the processing system 1 will be described. It is assumed that the plan (that is, sequence) generated by the generation unit 202 be notified to the management system 10. When the plan is notified from the generation unit 202 to the management system 10, it is assumed that the control unit 103 display a notification for inquiring whether the work has been completed on the display unit 104, in response to the notification.

The task instruction device 201 instructs the controller 204 to perform the task for causing the robot 205 to execute the sorting work for transferring the product M in the cardboard C conveyed by the belt conveyor to the tray T, putting the tray T on another belt conveyor, and moving the tray T to a predetermined position, as the desired work (step S1). For example, the task instruction device 201 outputs the type of the product M, the number of products M to be moved, the movement source of the product M, and the information indicating the destination of the product M, the information indicating the unit of the predetermined work for confirming the completion of the work, or the like to the generation unit 202, as the work target. For example, the task instruction device 201 outputs, to the generation unit 202, the entry prohibition region when moving the product M, the region departing from the movable range of the robot 205, and in addition, the conditions of the surface of the product M regarding gripping the product M, releasing the gripping of the product M, or regripping the product M, as the constraint condition.

The generation unit 202 generates the plan indicating the flow of the operation of the robot 205, based on the work target and the constraint condition input by the task instruction device 201.

For example, in a case where the work for moving the cardboard C from the stopping position of the belt conveyor onto the work table F by the robot 205 has been completed, the generation unit 202 generates the fifth sequence for moving the product M in the cardboard C on the work table F to the tray T (step S2). The generation unit 202 generates the sixth sequence for confirming whether the work according to the fifth sequence has been completed. The generation unit 202 notifies the management system 10 of that the fifth sequence has been generated (step S3). The control unit 103 displays display according to the fifth sequence (for example, displays illustrated in FIGS. 3 to 8) on the display unit 104, at the predetermined timing, in response to the notification (step S4).

The generation unit 202 outputs the generated fifth sequence to the controller 204. The controller 204 generates the control signal for controlling the robot 205 to move the product M in the cardboard C on the work table F to the tray T, based on the fifth sequence output by the generation unit 202 (step S5).

The controller 204 outputs the generated control signal to the robot 205. The robot 205 moves the product M in the cardboard C on the work table F to the tray T, in response to the control signal output by the controller 204 (step S6). The generation unit 202 generates the sixth sequence for confirming whether the work according to the fifth sequence has been completed (step S7). The determination unit 206 determines whether the work according to the fifth sequence has been completed, according to the sixth sequence generated by the generation unit 202 (step S8).

In a case where the determination unit 206 determines that the work according to the fifth sequence has not been completed (NO in step S8), the controller 204 generates the control signal for moving the product M to be within the predetermined range again, for example, based on the information regarding the product M acquired by the camera 203 at the moving destination (step S9). Then, the controller 204 outputs the generated control signal to the robot 205. The robot 205 moves the product M to be within the predetermined range (step S10). Then, the robot 205 returns to the processing in step S8.

In a case where the determination unit 206 determines that the work according to the fifth sequence has been completed (YES in step S8), the recognition unit 208 specifies the specific figure associated with the notification of the work determined to be completed by the determination unit 206. Then, the recognition unit 208 specifies a figure matching the specified specific figure, from among the specific figures displayed on the display unit 104, in the information (that is, plane image) acquired by the camera 203 (step S11). The specification unit 209 specifies the specific figure matching the specific figure specified by the recognition unit 208, in a database DB1 stored in the storage unit 207 (step S12).

Then, the specification unit 209 specifies a posture (position and direction) of the specified specific figure in the three-dimensional space of the work place (step S13).

The controller 204 generates the control signal for touching the specific figure with the stylus pen according to the posture specified by the specification unit 209 (step S14). Then, the controller 204 outputs the generated control signal to the robot 205. The robot 205 touches the specific figure related to the completion of the work with the stylus pen (step S15). Through the processing in step S15, the completion of the work for moving the product M in the cardboard C to the tray T is notified to the management system 10. The management unit 101 rewrites a flag, stored in the storage unit 102, related to the work for moving the product M in the cardboard C to the tray T from 0 (unprocessed) to 1 (processed) (step S16). The processing in step S16 makes it possible to manage progress of each work by the management system 10.

The display by the display unit 104 described in the processing flow illustrated in FIG. 13 is merely an example, and is not limited to the display described in the processing flow. As described with reference to FIGS. 3 to 8 or the like, the display unit 104 performs display according to the processing at the predetermined timing, under the control of the control unit 103.

### Advantages

The processing system 1 according to one example embodiment of the present disclosure has been described above. The management system 10 (example of control device) of the processing system 1 includes the control unit 103 (example of control means) that creates the display information including the input form for receiving the input from outside and the information regarding the operation of the robot displayed to be superimposed on the input form.

In this way, the management system 10 can display and superimpose the input form and the information regarding the operation of the robot displayed to be superimposed on the input form. As a result, the management system 10 can control software related to the work regardless of a type of an operation subject (worker or robot).

In one example embodiment of the present disclosure, it has been described that, in the robot system 20, the task instruction device 201 only instructs the task for executing the work, the generation unit 202 generates the sequence, the controller 204 generates the control signal according to the sequence, and the robot 205 can be controlled by the control signal. However, in another example embodiment of the present disclosure, the task instruction device 201 may instruct the task for executing the work, for each optional work unit, for example, each unit of the predetermined work described in one example embodiment of the present disclosure.

That is, in the robot system 20 according to another example embodiment of the present disclosure, the task is instructed for each optional work unit, the generation unit 202 generates the sequence for each instruction, the controller 204 generates the control signal according to the sequence, and the robot 205 may be controlled by the control signal. The optional work unit includes stopping.

In one example embodiment of the present disclosure, it has been described that the display unit 104 is the display with the touch panel function. However, in another example embodiment of the present disclosure, the display unit 104 is not limited to the display with the touch panel function. For example, the display unit 104 may be a display that makes a response in a non-contact close manner and makes a response by bringing the stylus pen or the like close to the display.

In one example embodiment of the present disclosure, it has been described that the robot 205 uses the stylus pen to respond the specific figure. However, in another example embodiment of the present disclosure, in a range where the display unit 104 responds, the robot 205 may use an object other than the stylus pen to respond the specific figure. Examples of the object other than the stylus pen include an object made of a conductor, an object having a rod-like shape, or the like.

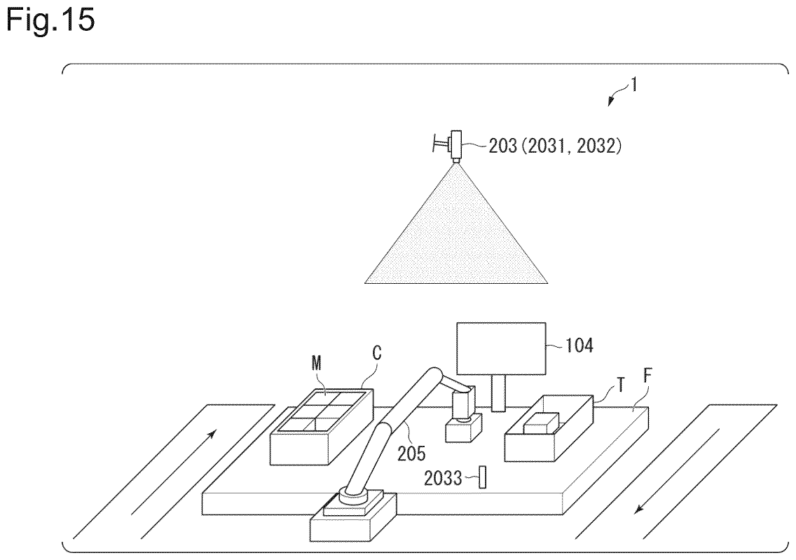

In one example embodiment of the present disclosure, it has been described that the posture of the specific figure displayed on the display unit 104 is specified, based on the information acquired by the camera 203 including the two-dimensional camera 2031 and the depth camera 2032. However, depending on an installation position of the camera 203, there is a possibility that it is not possible to specify the posture of the specific figure displayed on the display unit 104, only based on the information acquired by the camera 203. Therefore, the camera 203 according to another example embodiment of the present disclosure is not limited to the camera including the two-dimensional camera 2031 and the depth camera 2032. FIG. 15 is an image diagram of the surrounding environment of the processing system 1 according to one example embodiment of the present disclosure. The camera 203 according to one example embodiment of the present disclosure includes the two-dimensional camera 2031 and the depth camera 2032 similarly to the camera 203 according to one example embodiment of the present disclosure, and may further include a two-dimensional camera 2033 that is provided at a position where it is easy to image the display unit 104, as illustrated in FIG. 15.

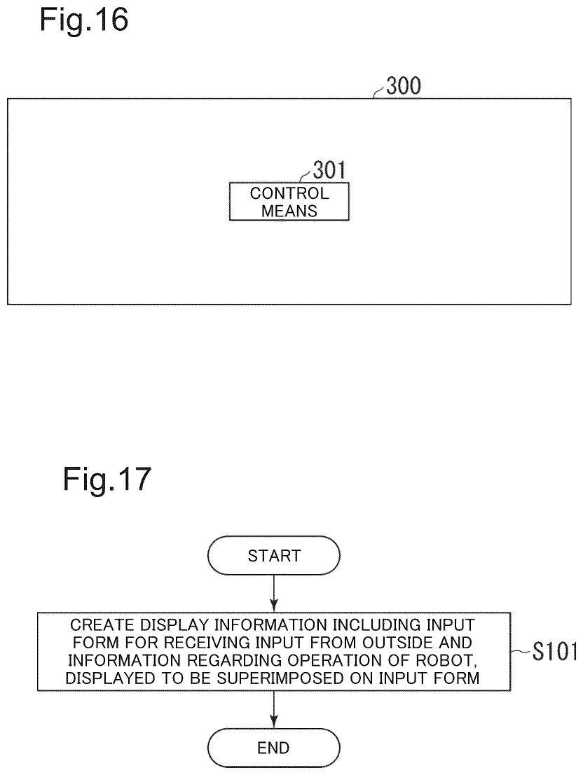

Next, a control device 300 having a minimum configuration according to the example embodiment of the present disclosure will be described. FIG. 16 is a diagram illustrating an example of the control device 300 having the minimum configuration according to one example embodiment of the present disclosure. The control device 300 having the minimum configuration includes control means 301.

The control means 301 creates display information including an input form for receiving an input from outside and information regarding the operation of the robot, displayed to be superimposed on the input form. The control means 301 can be achieved, for example, using a function of the control unit 103 illustrated in FIG. 2.

Next, processing executed by the control device 300 having the minimum configuration will be described. FIG. 17 is a diagram illustrating an example of a processing flow of the control device 300 having the minimum configuration according to one example embodiment of the present disclosure. Here, the processing of the control device 300 having the minimum configuration will be described with reference to FIG. 17.

In the control device 300, the control means 301 creates the display information including the input form for receiving the input from outside and the information regarding the operation of the robot, displayed to be superimposed on the input form (step S101).

The control device 300 having the minimum configuration according to one example embodiment of the present disclosure has been described above. According to the control device 300, it is possible to control the software related to the work regardless of the type of the operation subject.

Although the example embodiment of the present disclosure has been described, the processing system 1, the management system 10, the robot system 20, and the other control device may include a computer device therein. The process of the above-described processing is stored in a computer-readable recording medium in a form of a program, and the above-described processing is executed by the computer reading and executing the program. A specific example of the computer will be described below.

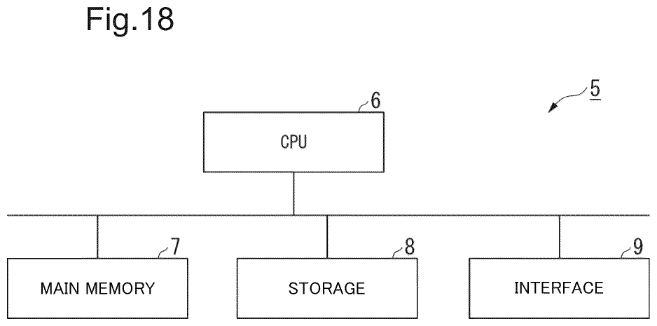

FIG. 18 is a schematic block diagram illustrating a configuration of a computer according to at least one example embodiment. As illustrated in FIG. 18, a computer 5 includes a Central Processing Unit (CPU) 6, a main memory 7, a storage 8, and an interface 9. For example, each of the processing system 1, the management system 10, the robot system 20, and the other control device is implemented by the computer 5. Then, the operation of each processing unit described above is stored in the storage 8 in the form of the program. The CPU 6 reads the program from the storage 8, loads the program in the main memory 7, and executes the above processing according to the program. The CPU 6 secures a storage area associated with each of the above-described storage units in the main memory 7 according to the program.

Examples of the storage 8 include a Hard Disk Drive (HDD), a Solid State Drive (SSD), a magnetic disk, a magneto-optical disk, a Compact Disc Read Only Memory (CD-ROM), a Digital Versatile Disc Read Only Memory (DVD-ROM), a semiconductor memory, and the like. The storage 8 may be an internal medium directly connected to a bus of the computer 5 or an external medium connected to the computer 5 via the interface 9 or a communication line. In a case where the program is distributed to the computer 5 through the communication line, the computer 5 that has received the distribution may load the program in the main memory 7 and execute the above processing. In at least one example embodiment, the storage 8 is a non-transitory tangible recording medium.

The program may achieve a part of the functions described above. Moreover, the program may be a file that can achieve the above-described functions in combination with a program already recorded in the computer device, that is, a so-called difference file (difference program).

The order of processing in each example embodiment of the present disclosure may be changed within a range in which appropriate processing is performed.

Although some example embodiments of the present disclosure have been described, these example embodiments are examples and do not limit the scope of the disclosure. Various additions, omissions, substitutions, and changes may be made to these example embodiments without departing from the gist of the disclosure.

Some or all of the above example embodiments may be described as the following Supplementary Notes, but are not limited to the following.

### Supplementary Note 1

A control device including:
control means for creating display information including an input form for receiving an input from outside and information regarding an operation of a robot, displayed to be superimposed on the input form.

### Supplementary Note 2

The control device according to supplementary note 1, in which
the control means
changes display content of the display information.

### Supplementary Note 3

The control device according to supplementary note 2, in which
the control means
changes the display content of the display information, after a predetermined operation of the robot has been completed.

### Supplementary Note 4

The control device according to any one of supplementary notes 1 to 3, in which
the control means
hides display of the display information.

### Supplementary Note 5

The control device according to supplementary note 4, in which
the control means
hides the display of the display information, after the predetermined operation of the robot has been completed.

### Supplementary Note 6

The control device according to any one of supplementary notes 1 to 5, in which
the control means
displays an estimated timing when the operation of the robot is completed in a predetermined process.

### Supplementary Note 7

The control device according to any one of supplementary notes 1 to 6, in which
the control means
displays the display information at a timing when the operation of the robot has been completed in the predetermined process or an estimated timing when the operation of the robot is likely to be completed in the predetermined process.

### Supplementary Note 8

The control device according to any one of supplementary notes 1 to 7, in which
the display information is
information indicating control content for the robot.

### Supplementary Note 9

The control device according to any one of supplementary notes 1 to 8, in which
the display information is
information indicating a desired state achieved by the robot.

### Supplementary Note 10

A control method including:
creating display information including an input form for receiving an input from outside and information regarding an operation of a robot, displayed to be superimposed on the input form.

### Supplementary Note 11

A recording medium storing a program for causing a computer to execute:
creating display information including an input form for receiving an input from outside and information regarding an operation of a robot, displayed to be superimposed on the input form.

### INDUSTRIAL APPLICABILITY

According to each aspect of the present disclosure, it is possible to control software related to a work regardless of a type of an operation subject.

### REFERENCE SIGNS LIST

1 processing system
5 computer
6 CPU
7 main memory
8 storage
9 interface
10 management system
20 robot system
101 management unit
102, 207 storage unit
103 control unit
104 display unit
201 task instruction device
202 generation unit
203 camera
204 controller
205 robot
206 determination unit
208 recognition unit
209 specification unit
C cardboard
M product
T tray

What is claimed is:

1. A control device comprising:
a controller configured to create display information including an input form for receiving an input from outside and information regarding an operation of a robot, displayed to be superimposed on the input form.

2. The control device according to claim 1, wherein
the controller
changes display content of the display information.

3. The control device according to claim 2, wherein
the controller
changes the display content of the display information, after a predetermined operation of the robot has been completed.

4. The control device according to claim 1, wherein
the controller
hides display of the display information.

5. The control device according to claim 4, wherein
the controller
hides the display of the display information, after the predetermined operation of the robot has been completed.

6. The control device according to claim 1, wherein
the controller
displays an estimated timing when the operation of the robot is completed in a predetermined process.

7. The control device according to claim 1, wherein
the controller
displays the display information at a timing when the operation of the robot has been completed in the predetermined process or an estimated timing when the operation of the robot is completed in the predetermined process.

8. The control device according to claim 1, wherein
the display information is
information indicating control content for the robot.

9. The control device according to claim 1, wherein
the display information is
information indicating a desired state to be achieved by the robot.

10. A control method comprising:
creating display information including an input form for receiving an input from outside and information regarding an operation of a robot, displayed to be superimposed on the input form.

11. A non-transitory recording medium storing a program for causing a computer to execute:
creating display information including an input form for receiving an input from outside and information regarding an operation of a robot, displayed to be superimposed on the input form.
